(19) United States
(12) Patent Application Publication
(10) Pub. No.: US 2018/0083681 A1
(43) Pub. Date: Mar. 22, 2018

(54) A CSI Report Framework for Enhanced Separate Dimension Feedback

(71) Applicant: Telefonaktiebolaget LM Ericsson (publ), Stockholm (SE)

(72) Inventors: Sebastian Faxér, Järfälla (SE); Mattias Frenne, Uppsala (SE); Niklas Wernersson, Kungsängen (SE)

(21) Appl. No.: 15/554,195

(22) PCT Filed: Feb. 1, 2016
(86) PCT No.: PCT/SE2016/050071

§ 371 Date: Aug. 28, 2017

Related U.S. Application Data
(60) Provisional application No. 62/109,824, filed on Jan. 30, 2015.

(51) Int. Cl. H04B 7/06; H04B 7/0413

(52) U.S. Cl. CPC H04B 7/0626; H04W 84/042; H04B 7/0413

(57) ABSTRACT

There is disclosed a method for operating a MIMO transmitting node (100) for a wireless communication network. The method comprises configuring a receiving node (10) for determining CSI feedback for a first number Ncsi_ports of separate CSI-RS ports, the first number Ncsi_ports being smaller than a second number Nports of ports used for data transmission to the receiving node (10), wherein configuring comprises signaling the first number Ncsi_ports and the second number Nports to the receiving node (10). The disclosure also pertains to related methods and devices.

### TECHNICAL FIELD

The present disclosure pertains to wireless communication technology, in particular in the context of multi-antenna arrays and measurement report (CSI processes).

### BACKGROUND

Multi-antenna techniques (MIMO techniques) are used more and more in wireless communication systems. With increasing number of antenna elements being used, the systems become more and more flexible and provide useful advantages in particular regarding efficient use of power and beam-forming. However, the increased flexibility requires new approaches of handling signaling, e.g. to keep signaling overhead at an acceptable level.

### SUMMARY

An object of this disclosure is to provide approaches related to CSI-process in multi-antenna scenarios.

In particular, there is disclosed a method for operating a MIMO transmitting node for a wireless communication network. The method comprises configuring a receiving node for determining CSI feedback for a first number Ncsi_ports of separate CSI-RS ports, the first number Ncsi_ports being smaller than a second number Nports of ports used for data transmission to the receiving node, wherein configuring comprises signaling the first number Ncsi_ports and the second number Nports to the receiving node.

Moreover, there is described a MIMO transmitting node for a wireless communication network. The MIMO transmitting node is adapted for configuring a receiving node for determining CSI feedback for a first number Ncsi_ports of separate CSI-RS ports, the first number Ncsi_ports being smaller than a second number Nports of ports used for data transmission to the receiving node, wherein configuring comprises signaling the first number Ncsi_ports and the second number Nports to the receiving node.

A method for operating a receiving node for a wireless communication network is also disclosed. The method comprises measuring CSI information of a transmission from a transmitting node on a first number Ncsi_ports of CSI, and determining a joint CSI report based on the measured CSI information out of the first number Ncsi_ports of CSI ports and/or processes.

There is also proposed a receiving node for a wireless communication network. The receiving node is adapted for measuring CSI information of a transmission from a transmitting node on a first number Ncsi_ports of CSI, and determining a joint CSI report based on the measured CSI information out of the first number Ncsi_ports of CSI ports and/or processes.

In addition, there is disclosed a storage medium adapted to store instructions executable by control circuitry, the instructions causing the control circuitry to carry out and/or control any one of the methods disclosed herein when executed by the control circuitry.

According to the approaches described, CSI processes can be performed more efficiently and/or with less overhead.

### BRIEF DESCRIPTION OF THE DRAWINGS

The drawings are provided to illustrate concepts and approaches of the disclosure and are not intended as limitation. The drawings comprise:

FIG. 1, showing a transmission structure of precoded spatial multiplexing mode in LTE;

FIG. 2, showing an illustration of a two-dimensional antenna array of cross-polarized antenna elements;

FIG. 3, showing antenna elements in a vertical CSI-RS transmission process;

FIG. 4, showing antenna elements where a horizontal CSI process is transmitted;

FIG. 5, schematically showing a terminal; and

FIG. 6, schematically showing a network node.

### DETAILED DESCRIPTION

Note that although terminology from 3GPP LTE has been used in this disclosure to by way of example, this should not be seen as limiting the scope of the approach described to only the aforementioned system. Other wireless systems, including WCDMA, WiMax, UMB and GSM, may also benefit from exploiting the ideas covered within this disclosure.

Also note that terminology such as eNodeB and UE should be considering non-limiting and does in particular not imply a certain hierarchical relation between the two; in general “eNodeB” could be considered as device 1 and “UE” device 2, and these two devices communicate with each other over some radio channel. Herein, it is focused on wireless transmissions in the downlink, but the approach is equally applicable in the uplink.

Codebook-based precoding is described in the following.

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO.

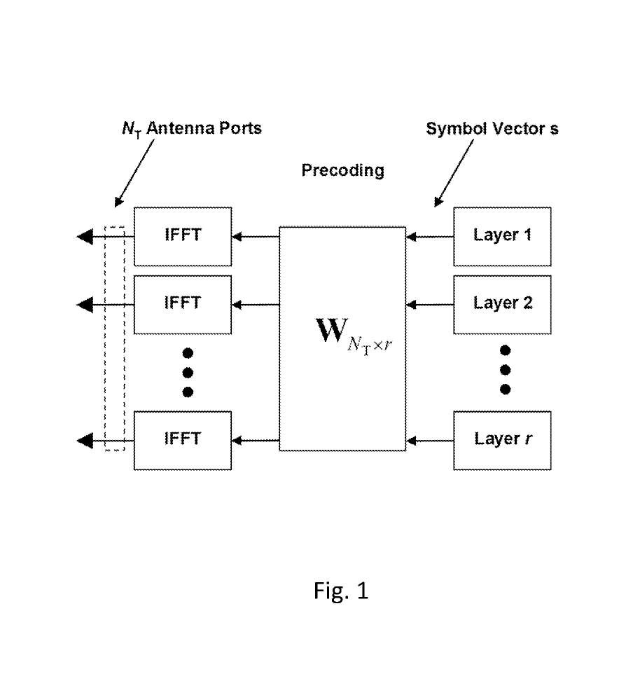

The LTE standard is currently evolving with enhanced MIMO support. A core component in LTE is the support of MIMO antenna deployments and MIMO related techniques. Currently LTE-Advanced supports an 8-layer spatial multiplexing mode for 8 Tx antennas with channel dependent precoding. The spatial multiplexing mode is aimed for high data rates in favorable channel conditions. An illustration of the spatial multiplexing operation is provided in FIG. 1.

As seen, the information carrying symbol vector s is multiplied by an N_{T}×r precoder matrix w, which serves to distribute the transmit energy in a subspace of the N_{T} (corresponding to N_{T} antenna ports) dimensional vector space. The precoder matrix is typically selected from a codebook of possible precoder matrices, and typically indicated by means of a precoder matrix indicator (PMI), which specifies a unique precoder matrix in the codebook for a given number of symbol streams. The r symbols in s each correspond to a layer and r is referred to as the transmission rank. In this way, spatial multiplexing is achieved since multiple symbols can be transmitted simultaneously over the same time/frequency resource element (TFRE). The number of symbols r is typically adapted to suit the current channel properties.

LTE uses OFDM in the downlink (and DFT precoded OFDM in the uplink) and hence the received N_{R}×1 vector yₙ for a certain TFRE on subcarrier n (or alternatively data TFRE number n) is thus modeled by

yₙ=HₙWsₙ+eₙ

where eₙ is a noise/interference vector obtained as realizations of a random process. The precoder, can be a wideband precoder, which is constant over frequency, or frequency selective.

The precoder matrix is often chosen to match the characteristics of the N_{R}×N_{T} MIMO channel matrix H, resulting in so-called channel dependent precoding. This is also commonly referred to as closed-loop precoding and essentially strives for focusing the transmit energy into a subspace which is strong in the sense of conveying much of the transmitted energy to the UE. In addition, the precoder matrix may also be selected to strive for orthogonalizing the channel, meaning that after proper linear equalization at the UE, the inter-layer interference is reduced. The transmission rank, and thus the number of spatially multiplexed layers, is reflected in the number of columns of the precoder. For efficient performance, it is important that a transmission rank that matches the channel properties is selected. Channel State Information Reference Symbols (CSI-RS) are discussed in the following.

In LTE Release-10, a new reference symbol sequence was introduced for the intent to estimate channel state information, the CSI-RS. The CSI-RS provides several advantages over basing the CSI feedback on the common reference symbols (CRS) which were used, for that purpose, in previous releases. Firstly, the CSI-RS is not used for demodulation of the data signal, and thus does not require the same density (i.e., the overhead of the CSI-RS is substantially less). Secondly, CSI-RS provides a much more flexible means to configure CSI feedback measurements (e.g., which CSI-RS resource to measure on can be configured in a UE specific manner). By measuring on a CSI-RS a UE can estimate the effective channel the CSI-RS is traversing including the radio propagation channel and antenna gains. In more mathematical rigor this implies that if a known CSI-RS signal x is transmitted, a UE can estimate the coupling between the transmitted signal and the received signal (i.e., the effective channel). Hence if no virtualization is performed in the transmission the received signal y can be expressed as

y=Hx+e

and the UE can estimate the effective channel H.

Up to eight CSI-RS ports can be configured, that is, the UE can estimate the channel from up to eight transmit antennas.

Related to CSI-RS is the concept of zero-power CSI-RS resources (also known as a muted CSI-RS) that are configured just as regular CSI-RS resources, so that a UE knows that the data transmission is mapped around those resources. The intent of the zero-power CSI-RS resources is to enable the network to mute the transmission on the corresponding resources in order to boost the SINR of a corresponding non-zero power CSI-RS, possibly transmitted in a neighbor cell/transmission point. For Rel-11 of LTE a special zero-power CSI-RS was introduced that a UE is mandated to use for measuring interference plus noise. A UE can assume that the TPs of interest are not transmitting on the zero-power CSI-RS resource, and the received power can therefore be used as a measure of the interference plus noise.

Based on a specified CSI-RS resource and on an interference measurement configuration (e.g. a zero-power CSI-RS resource), the UE can estimate the effective channel and noise plus interference, and consequently also determine which rank, precoder and transport format to recommend that best match the particular channel.

CSI-RS and corresponding signaling may generally be seen as representative of reference signaling (which may also be referred to as pilot signaling). Such reference signaling may be carried on and/or associated to a dedicated and/or shared channel (in particular, a logical or physical channel).

Implicit CSI Feedback is discussed in the following.

For CSI feedback LTE has adopted an implicit CSI mechanism where a UE does not explicitly report e.g., the complex valued elements of a measured effective channel, but rather the UE recommends a transmission configuration for the measured effective channel. The recommended transmission configuration thus implicitly gives information about the underlying channel state.

In LTE the CSI feedback is given in terms of a transmission rank indicator (RI), a precoder matrix indicator (PMI), and one or two channel quality indicator(s) (CQI). The CQI/RI/PMI report can be wideband or frequency selective depending on which reporting mode that is configured.

The RI corresponds to a recommended number of streams that are to be spatially multiplexed and thus transmitted in parallel over the effective channel. The PMI identifies a recommended precoder (in a codebook which contains precoders with the same number of rows as the number of CSI-RS ports) for the transmission, which relates to the spatial characteristics of the effective channel. The CQI represents a recommended transport block size (i.e., code rate) and LTE supports transmission of one or two simultaneous (on different layers) transmissions of transport blocks (i.e. separately encoded blocks of information) to a UE in a subframe. There is thus a relation between a CQI and an SINR of the spatial stream(s) over which the transport block or blocks are transmitted.

An exemplary CSI Process is discussed in the following.

In LTE Release 11, CSI processes are defined such that each CSI process is associated with a CSI-RS resource and a CSI-IM resource. A UE in transmission mode 10 can be configured with one or more (up to four) CSI processes per serving cell by higher layers and each CSI reported by the UE corresponds to a CSI process. A UE may be configured with a RI-reference CSI process for any CSI process, such that the reported RI for the CSI process is the same as for the RI-reference CSI process. This configuration may be used to force a UE to report the same RI for several different interference hypotheses, even though another RI would be the best choice for some hypotheses. Furthermore, a UE is restricted to report PMI and RI within a precoder codebook subset configured for each CSI process by higher layer signaling. This configuration may also be used to force a UE to report a specific rank for a certain CSI process.

Generally, in a CSI process, a UE may perform measurements on received CSI-RS signaling and/or provide CSI feedback (a form of measurement reporting) based on the measurements. CSI feedback may in particular comprise RI, PMI and one or more CQI/s.

2D antenna arrays are discussed in the following.

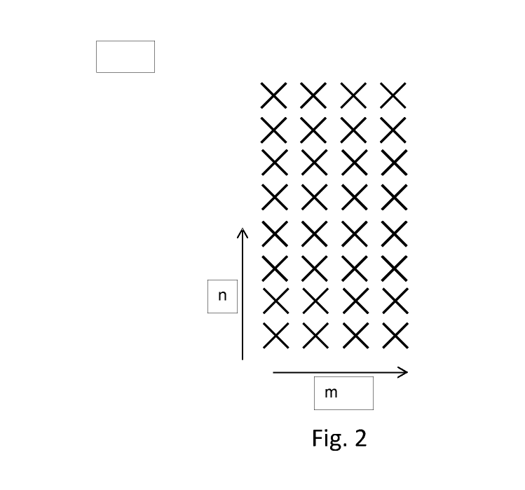

Recent development in 3GPP has led to the discussion of two-dimensional antenna arrays where each antenna element has an independent phase and amplitude control, thereby enabling beamforming in both in the vertical and the horizontal dimension. Such antenna arrays may be (partly) described by the number of antenna columns corresponding to the horizontal dimension Mₖ, the number of antenna rows corresponding to the vertical dimension Mᵥ and the number of dimensions corresponding to different polarizations Mₚ. The total number of antennas is thus M=MₕMᵥMₚ. An example of an antenna where Mₖ=8 and Mᵥ=4 is illustrated in FIG. 2. It furthermore consist of cross-polarized antenna elements meaning that Mₚ=2. Such an antenna is denoted as an 8×4 antenna array with cross-polarized antenna elements.

The horizontal and vertical directions may be chosen arbitrarily (e.g., the horizontal does not necessarily have to be parallel to a geographically horizontal line and/or parallel to the ground), in particular such that they are orthogonal to each other.

It should be pointed out that the concept of an antenna element is nonlimiting in the sense that it can refer to any virtualization (e.g., linear mapping) of a transmitted signal to the physical antenna elements. For example, groups of physical antenna elements could be fed the same signal, and hence they share the same virtualized antenna port when observed at the receiver. Hence, the receiver cannot distinguish and measure the channel from each individual antenna element within the group of element that are virtualized together. Hence, the terms “antenna element”, “antenna port” or simply “port” should be considered interchangeable in this document.

Precoding may be interpreted as multiplying the signal with different beamforming weights for each (virtual) antenna port prior to transmission. A typical approach is to tailor the precoder to the antenna form factor, i.e. taking into account Mₕ, Mᵥ and Mₚ when designing the precoder codebook.

An approach when designing precoder codebooks tailored for 2D antenna arrays is to combine precoders tailored for a horizontal array and a vertical array of antenna ports respectively by means of a Kronecker product. This means that (at least part of) the precoder can be described as a function of

W_{H} [symbol] W_{V}

where W_{H} is a horizontal precoder taken from a (sub)-codebook x_{H} containing N_{H} codewords and similarly W_{V} is a vertical precoder taken from a (sub)-codebook X_{V} containing N_{V} codewords. The joint codebook, denoted X_{H} [symbol] X_{V}, thus contains N_{H}·N_{V} codewords. The elements of X_{H} are indexed with k=0, . . . , N_{H}−1, the elements of X_{V} are indexed with l=0, . . . , N_{V}−1 and the elements of the joint codebook X_{H} [symbol] X_{V} are indexed with m=N_{V}·k+l meaning that m=0, . . . , N_{H}·N_{V}−1. The Kronecker product A [symbol] B between two matrices

$$A = [ \begin{matrix}{A}_{1 , 1} & … & {A}_{1 , M} \\ ⋮ & ⋱ & ⋮ \\ {A}_{N , 1} & … & {A}_{N , M}\end{matrix} ]$$

and B is defined as

$$A ⊗ B = [ \begin{matrix}{A}_{1 , 1} B & … & {A}_{1 , M} B \\ ⋮ & ⋱ & ⋮ \\ {A}_{N , 1} B & … & {A}_{N , M} B\end{matrix} ] ,$$

A scheme with separate horizontal and vertical CSI feedback is described in the following.

To acquire CSI feedback in the case where a 2D antenna array of antenna ports is used one may use one CSI-RS per antenna port in order to enable the UE to fully estimate the MIMO channel matrix H and be able to calculate and feed back a PMI, CQI and RI reflecting knowledge of the full channel. However, this poses a problem since the LTE standard currently only supports a maximum of 8 CSI-RS antenna ports. With the 8×4 antenna illustrated in the previous section, M=MᵥMₕMₚ=8·4·2=64 CSI-RS ports would be required.

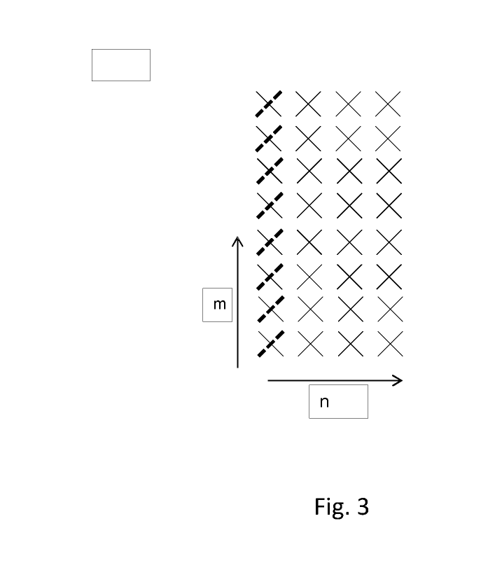

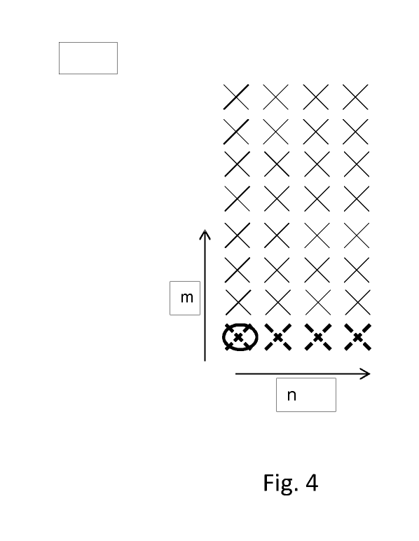

A discussed solution to this problem is to use so called separate dimension feedback, meaning that two separate CSI processes are used to acquire CSI: one vertical CSI process with Mᵥ CSI-RS antenna ports and one horizontal CSI process with MₕMₚ CSI-RS antenna ports. The vertical CSI-RS could be transmitted on antenna elements from a single column and a single polarization of the antenna array, as is illustrated in FIG. 3. Based on these vertical CSI-RS (which is denoted “V-CSI-RS”), the UE can estimate a partial channel matrix Hᵥ. Similarly, the horizontal CSI-RS (which is denoted “H-CSI-RS”) could be transmitted on a single row of the antenna array, such as is illustrated in FIG. 4. Based on said horizontal CSI-RS, the UE could then accordingly estimate another partial channel matrix H_{H}.

For each of these separate CSI processes, the UE selects and feeds back a PMI, CQI and RI indicating the CSI of the partial channels H_{V} and H_{H} respectively. That is, the network node or eNodeB will receive two sets of CSI values (in this example).

The network node or eNodeB may then, based on PMI_{V} (indicating the precoder W_{V}) and PMI_{H} (indicating the precoder W_{H}) create a combined 2D precoder using a Kronecker product

W=W_{H} [symbol] W_{V}, as discussed in the previous section.

With this scheme, two-dimensional beamforming can be accomplished using the current LTE Rel-12 standard, i.e. without having to increase the number of CSI-RS ports or designing a new codebook.

Note that the vertical CSI-RS are transmitted on only one of the polarizations in this example, while the horizontal CSI-RS are transmitted on both polarizations. With such a setup, the reported rank of the vertical CSI process could be fixed to one in the configuration of the CSI process. The transmission rank would then be decided entirely by the horizontal CSI process.

A crossover element is defined as the antenna element which is measured by both the vertical and horizontal CSI process.

A problem with the separate feedback scheme is that the reported CQI and RI values does not accurately reflect the CSI of the full channel H, since they have been calculated using the partial channels H_{V} and H_{H}, and respectively the corresponding matrices.

It is not obvious how the eNodeB should decide upon a modulation and coding scheme (MCS) and a rank based upon these two partial feedback reports. Choosing MCS and rank suboptimally may lead to link adaptation errors which may spoil system performance.

Using two separate CSI process creates an unnecessary strain in terms of overhead, interference and power consumption on the uplink feedback channel since, in some sense, duplicate information is sent. For periodic CSI reporting on the PUCCH, where the payload size is limited to only a few bits, this may be unwanted.

Moreover, array antennas should not be constrained to the legacy sizes of 1,2,4 or 8 antenna ports. It is a problem how to provide CSI feedback for one or two dimensional antenna arrays with arbitrary integers of antenna ports in each dimension.

A new kind of CSI reporting framework that defines N_{csi}_{_}ₚₒᵣₜₛ CSI-RS ports for measurements is provided, wherein N_{csi}_{_}ₚₒᵣₜₛ may be smaller than the number of ports Nₚₒᵣₜₛ used for shared data channel transmission (which may correspond to the number of antenna ports used for the transmission). When configuring the CSI process, the UE is signaled information of how to reconstruct a full (Nₚₒᵣₜₛ) channel estimate based upon the partial (N_{csi}_{_}ₚₒᵣₜₛ) channel estimate.

The UE then calculates and feeds back a single, joint, PMI/CQI/RI that has been calculated based on the partial channel knowledge from the N_{csi}_{_}ₚₒᵣₜₛ ports. The PMI/CQI/RI thus correspond to the Nₚₒᵣₜₛ transmission used for the shared data channel.

Accordingly, there is described a method for operating a MIMO transmitting node like a network node (which may be an eNodeB), the method comprising configuring a receiving node like a terminal for determining CSI feedback for a first number Ncsi_ports of separate CSI-RS ports, the first number Ncsi_ports being smaller than a second number Nports of ports and/or antenna ports used for data transmission to the terminal, wherein configuring comprises signaling the first number Ncsi_ports and the second number Nports to the terminal.

The transmitting node, e.g. network node, may be adapted for such configuring and/or comprise a configuring module for such configuring. Configuring may comprise signaling, to the terminal, allocation or configuration data (in particular configuration data pertaining to a joint CSI report), which may include e.g. an indication of a split of the antenna ports into separate dimensions and/or one or more crossover element positions. The transmitting node may transmit, and/or be adapted for transmitting and/or comprise a transmitting module for transmitting, data, e.g. to the receiving node, utilizing the second number Nports of antenna ports for transmission, e.g. split and/or separated into separate dimensions; this transmitting may be based on and/or performed after the configuring.

A MIMO transmitting node or more generally transmitting mode may generally be a node adapted to transmit to another node (receiving node) utilizing an antenna array allowing MIMO operation, in particular utilizing a separate dimensions as discussed herein. Such a transmitting node may be a network node like an eNodeB, but may also be a terminal or UE. A MIMO transmitting node may comprise and/or be connected or connectable to a corresponding MIMO antenna arrangement, in particular a 2D antenna arrangement, which may have at least 4 antenna elements.

Moreover, there is disclosed a method for operating a receiving node like a terminal, the method comprising measuring CSI information of a transmission (e.g. on a shared channel) from a transmitting node (which may be the (MIMO) transmitting node mentioned above) on a first number Ncsi_ports of CSI ports (which may be split and/or separated into separate dimensions) and/or processes (the CSI information for each port/processes may be separate and/or individual information), and determining a joint CSI report, which may be a single CSI report (e.g. with one PMI, RI and/or one or two CQI values only), based on the measured CSI information out of the first number Ncsi_ports of CSI ports and/or processes. There may be considered a receiving node, in particular a terminal, adapted for such determining and/or comprising a CSI determining module for such determining. The receiving node may be adapted for performing the measuring and/or comprise one or more correspondingly adapted measuring modules.

The measured CSI information, in particular each individual or separate CSI information relating to the individual ports Ncsi_ports, may comprise separate port information and/or partial channel information. The first number Ncsi_ports may be smaller than a second number Nports of antenna ports used by the transmitting node for transmission.

Determining a joint CSI report may be based on the configuration data like the second number Nports, and/or an indication of a split of the antenna ports into separate dimensions and/or one or more crossover element positions. Determining may be based on a configuration received from the transmitting node, which may e.g. comprise the configuration data or part of the configuration data.

The method may comprise receiving a configuration and/or configuration data to configure the receiving node and/or configuring the receiving node (by itself) based on received configuration or configuration data for measuring and/or determining the joint CSI report.

The receiving node may be adapted for such receiving and/or configuring, and/or may comprise a receiving module for such receiving and/or a configuring module for such configuring. The method may optionally comprise providing the joint CSI report, e.g. to the transmitting node and/or to the network, for example by transmitting the report. The receiving node may be adapted for such providing and/or transmitting, and/or may comprise a reporting module for such providing and/or transmitting.

Generally, determining a joint CSI report may comprise providing estimates and/or performing calculations based on the individual CSI measurements and/or configuration data. There may be determined partial channel estimates, which in particular may refer to the separate dimensions the antenna ports are split up into. Determining a joint CSI report may comprise utilizing one or more codebooks, e.g. to calculate and/or determine (partial) channel estimates or values. It may be considered that determining a joint CSI report may comprise mapping and/or relating the first number Ncsi_ports of CSI ports/measurements to the second number Nports of antenna ports used for transmission and/or the antenna configuration (e.g. the split into separate dimensions).

Configuration data, in particular configuration data pertaining to determining a joint CSI report, may comprise the second number Nports, and/or an indication of a split of the antenna ports into separate dimensions and/or one or more crossover element positions and/or codebook information and/or data indication an antenna configuration and/or data indicating and/or determining an arrangement of CSI ports (for measurements), in particular regarding a split of CSI ports (which may be associated to the (antenna) ports of the receiving node and/or available to the receiving node.

The separate dimensions CSI ports are spilt into may be analogous to the separate dimensions the antenna ports are split into.

An indication of a split of the antenna ports used for transmission (represented by Nports) may indicate that and/or in which way the antenna ports are split and/or separated into different dimensions. The indication may indicate into which dimensions the antenna ports are separated; alternatively or additionally, the receiving node may read corresponding information from a memory and/or implicitly assume a pre-defined dimensions, e.g. horizontal and vertical dimensions.

A crossover element may generally be an antenna element/port belonging to at least two separated dimensions.

A receiving node may generally be a node adapted to receive from another node (transmitting node) utilizing an antenna array allowing MIMO operation, in particular utilizing a separate dimensions as discussed herein. Such a receiving node may be a network node like an eNodeB, but may also be a terminal or UE. A receiving node may comprise and/or be connected or connectable to a corresponding MIMO antenna arrangement, in particular a 2D antenna arrangement, which may have at least 2 or 4 antenna elements.

Using the separate dimension feedback scheme within this framework instead of using two separate CSI processes has several advantages. One of the advantages is that uplink overhead is reduced due to that a single CQI and RI is fed back. Another advantage is that accurate CQI and RI are received by the network node or eNodeB. That is, there is no need for the network node or eNodeB to estimate CQI and RI values based on two separate CSI reports.

There is provided a novel CSI definition and configuration of CSI feedback framework for a UE served by an eNB which has an improved CSI measurement functionality and which may be explained by these general steps, in which term UE may be replace by receiving node and eNB by transmitting node:

1. The UE is configured by eNB by e.g. higher layer signaling such as RRC signaling, to measure upon N_{csi}_{_}ₚₒᵣₜₛ CSI-RS ports. The UE may also be configured by the eNB information of the split of N_{csi}_{_}ₚₒᵣₜₛ into the corresponding number Nv of vertical V-CSI-RS and number Nh of horizontal CSI-RS antenna ports such that N_{csi}_{_}ₚₒᵣₜₛ=Nh+Nv. The UE may also be configured the crossover element position by the eNB or the crossover element is implicitly given by reading specification text.

2. The UE is made aware that data transmission will occur using Nₚₒᵣₜₛ antenna ports, where Nₚₒᵣₜₛ is larger than N_{csi}_{_}ₚₒᵣₜₛ. By the information obtained in step 1, the UE is aware of the relation between the N_{csi}_{_}ₚₒᵣₜₛ CSI-RS and the Nₚₒᵣₜₛ antenna ports. This may be part of configuring the UE.

3. The UE determines, e.g. calculates, and feeds back a joint CSI report consisting of a CQI, a PMI and a RI. The joint CSI report is determined or calculated utilizing, at least partially, the information from step 1 and 2 and measurements from said N_{csi}_{_}ₚₒᵣₜₛ CSI-RS ports. The said CSI report corresponds to transmission of data over Nₚₒᵣₜₛ antenna ports.

4. How the UE is made aware of the information in step 1 and 2 may be implemented in several fashions. In some embodiments, the information may be included in the signaling of the configuration of the CSI process to the UE from the eNB. In other embodiments, the information may be conveyed over separate RRC signaling from the eNB to the UE. The information may also be broadcasted by the eNB to all UE in the cell in a broadcast message. The information may also be given to the UE in a handover process from another cell to the target cell which use the improved CSI measurement functionality. Furthermore, the information may be given by signaling from eNB to the UE on another cell used simultaneously by the UE in a dual connectivity operation or in a carrier aggregation operation of the UE. A subset of said information may, in some embodiments, already be known to the UE by e.g. signaling of codebook parameters. In other embodiments, a subset of the information may be predefined and known beforehand.

In one embodiment, the separate dimension feedback scheme is applied within the framework. The UE is configured to measure on N_{csi}_{_}ₚₒᵣₜₛ CSI-RS ports. The UE is then signaled or configured regarding the split of the antenna ports into separate dimensions, e.g. that a subset of said CSI-RS ports belong to a vertical CSI-RS group and that another subset of said CSI-RS ports belong to another, horizontal, CSI-RS group. Reusing the notation from earlier sections, these two sets of CSI-RS are denoted “V-CSI-RS” and “H-CSI-RS” respectively and the number of ports is Nv and Nh respectively. It is noted that these two subsets may overlap with a crossover element, such as is illustrated in FIG. 3 and FIG. 4.

In one further embodiment, the full channel measurement is used when the number of antenna ports used for data transmission Nₚₒᵣₜₛ is lower than a threshold value T which may be specified in standard. Hence, in this case, N_{csi}_{_}ₚₒᵣₜₛ=Nₚₒᵣₜₛ. When the number Nₚₒᵣₜₛ is larger than T, then the N_{csi}_{_}ₚₒᵣₜₛ<Nₚₒᵣₜₛ framework is assumed. A typical value for T=16 ports.

In a next step for the UE, after configuration discussed above, based on measurements performed using the V-CSI-RS and H-CSI-RS, the UE may construct two separate partial channel estimates:

$${H}_{V} = [ \begin{matrix}{h}_{V , 1}^{T} \\ ⋮ \\ {h}_{V , {M}_{R}}^{T}\end{matrix} ] and {H}_{H} = [ \begin{matrix}{h}_{H , 1}^{T} \\ ⋮ \\ {h}_{H , {M}_{R}}^{T}\end{matrix} ] .$$

Here h_{V,1}^{T} denotes the channel vector from the vertical antenna ports to receiver antenna 1 and M_{R} denotes the number of receiver antennas at the UE. Based upon these partial channels, the UE may reconstruct an estimate of the full channel as

$$\hat{H} = [ \begin{matrix}\frac{1}{{h}_{1 , 1}} {h}_{H , 1}^{T} ⊗ {h}_{V , 1}^{T} \\ ⋮ \\ \frac{1}{{h}_{1 , {M}_{R}}} {h}_{H , {M}_{R}}^{T} ⊗ {h}_{V , {M}_{R}}^{T}\end{matrix} ] ,$$

where h_{1,1} denotes the channel gain from CSI-RS port 1 to receiver antenna 1. Here it is assumed that CSI-RS port 1 correspond to the port that both an H-CSI-RS and a V-CSI-RS is transmitted on. Assuming that a Kronecker codebook is used for data transmission, i.e. the precoder has the structure W=W_{H} [symbol] W_{V}, the UE may estimate the received power as

$$\hat{P} = {‖ \hat{H} W ‖}^{2} = {‖ [ \begin{matrix}\frac{1}{{h}_{1 , 1}} {h}_{H , 1}^{T} ⊗ {h}_{V , 1}^{T} \\ ⋮ \\ \frac{1}{{h}_{1 , {M}_{R}}} {h}_{H , {M}_{R}}^{T} ⊗ {h}_{V , {M}_{R}}^{T}\end{matrix} ] {W}_{H} ⊗ {W}_{V} ‖}^{2} = {\sum }_{i = 1}^{{M}_{R}} {‖ ( \frac{1}{{h}_{1 , i}} {h}_{H , i}^{T} ⊗ {h}_{V , i}^{T} ) ( {W}_{H} ⊗ {W}_{V} ) ‖}^{2} = {\sum }_{i = 1}^{{M}_{R}} \frac{1}{{\vert {h}_{1 , i} \vert}^{2}} \cdot {‖ {h}_{H , i}^{T} {W}_{H} ‖}^{2} \cdot {‖ {h}_{V , i}^{T} {W}_{V} ‖}^{2} ,$$

where the Kronecker product rule has been used. The UE may then use said received power estimate to calculate a single PMI, CQI and RI, which is then fed back to the eNodeB.

Note that this method of full channel reconstruction based on V-CSI-RS and H-CSI-RS channel estimates is only an example of how such a reconstruction may be carried out. How the CQI/PMI/RI values are calculated is an implementation issue at the UE side, this example merely illustrates that such a reconstruction is possible.

In some variations of this embodiment, a single, joint, Nₚₒᵣₜₛ ports Kronecker precoder codebook is used. That is, the codebook contains precoders of the structure W=W_{H} [symbol] W_{V}, where the number of rows of W is Nₚₒᵣₜₛ. The UE may, or may not, be aware that W_{H} may be chosen from a (sub)-codebook X_{H} and that W_{V} may be chosen from a (sub)-codebook X_{V}. Depending on the implementation, the UE may report a single PMI, indicating a precoder in the joint Nₚₒᵣₜₛ port codebook X_{H} [symbol] X_{V} or it may report two separate PMIs, indicating precoders in the (sub)-codebooks X_{H} and X_{V} respectively.

In some, other, variations of this embodiment, a ternary codebook of the structure

$$W = [ \begin{matrix}{W}_{H} ⊗ {W}_{V} & 0 \\ 0 & {W}_{H} ⊗ {W}_{V}\end{matrix} ] {W}_{P}$$

is used. I.e the total precoder is constructed by three separate sub-precoder matrices where ark, may be an explicit polarization sub-precoder matrix. In such a case, the sub-precoder matrices W_{H} and W_{P} may be determined by using the H-CSI-RS channel estimate H_{H} and constructing a mockup precoder matrix

$$[ \begin{matrix}{W}_{H} & 0 \\ 0 & {W}_{H}\end{matrix} ] {W}_{P} .$$

Accordingly, W_{V} may be determined using the V-CSI-RS channel estimate.

In some other variations of said embodiment, the UE is signaled to use a separate codebook on the V-CSI-RS to determine W_{V} and a separate codebook on H-CSI-RS to determine W_{H} and feed back two separate PMIs. Said codebooks may for example be existing LTE Rel10 codebooks. Since only one RI is fed back in the CSI process, the UE may in some embodiments be configured by higher layers, either internally or by signaling from eNB, to fix the rank in one of the codebooks to one, and select the RI solely from the other codebook.

It is noted that, for example, the LTE Rel10 8Tx codebook use a dual codebook structure and it may be seen as that two PMIs are reported and not a single joint PMI in such a case.

Using the separate dimension feedback scheme within the framework instead of using two separate CSI processes has several advantages. One of the advantages is that uplink overhead is reduced due to that a single CQI and RI is fed back. Another advantage is that accurate CQI and RI is received by the eNodeB. That is, there is no need for the eNodeB to estimate CQI and RI values based on two separate CSI reports.

In another embodiment, the UE is configured to measure on N_{csi}_{_}ₚₒᵣₜₛ CSI-RS. The UE is also signaled a mapping between CSI-RS indices and antenna port indices.

In an illustrative example, the UE is configured to measure upon N_{csi}_{_}ₚₒᵣₜₛ=4 CSI-RS while data transmission occurs over Nₚₒᵣₜₛ=8 antenna ports. The corresponding mapping between CSI-RS port and antenna port is given in Table 1. In this example, the UE may construct a partial channel estimate from the CSI-RS, where the channel gain from every other antenna port may be estimated. The UE could, for instance, reconstruct the full channel as

$$\hat{H} = \sqrt{\frac{{N}_{ports}}{{N}_{{csi}_{ports}}}} [ \begin{matrix}{h}_{1 , 1} & 0 & {h}_{2 , 1} & 0 & {h}_{3 , 1} & 0 & {h}_{4 , 1} & 0 \\ ⋮ & ⋮ & ⋮ & ⋮ & ⋮ & ⋮ & ⋮ & ⋮ \\ {h}_{1 , {M}_{R}} & 0 & {h}_{2 , {M}_{R}} & 0 & {h}_{3 , {M}_{R}} & 0 & {h}_{4 , {M}_{R}} & 0\end{matrix} ] ,$$

where h_{2,1} denotes the estimate channel from CSI-RS port 2 to receiver antenna 1.

TABLE 1
An illustrative example of CSI-RS port to antenna port mapping.

| CSI-RS Port index | Antenna port index |
|---|---|
| 1 | 1 |
| 2 | 3 |
| 3 | 5 |
| 4 | 7 |

In another embodiment relating to the previous embodiment, the UE is also signaled which antenna configuration (Mₕ, Mᵥ, Mₚ) that is used and how the antenna port indices are related to the antenna dimensions, enabling the UE to estimate the channel from the Nₚₒᵣₜₛ−N_{csi}_{_}ₚₒᵣₜₛ “missing” antenna ports by interpolating between CSI-RS corresponding to spatially adjacent antenna elements with the same polarization.

For example, it may be assumed that the antenna rows are indexed with m=0, . . . , Mᵥ−1, the antenna columns are indexed with n=0, . . . , Mₕ−1 and the different polarizations are indexed with p=0, . . . , Mₚ. The antenna port indices i may for example be mapped to the antenna array elements as i=MₚMᵥp+Mᵥn+m. Given that the UE is aware of this mapping, in combination with knowledge about the antenna configuration (Mₕ, Mᵥ, Mₚ), it may deduct the antenna array position (m, n, p) of antenna port i. If, for instance, a CSI-RS is transmitted on antenna ports corresponding to array positions (m, n, p)=(2,3,1) and (m, n, p)=(4,3,1) but not on (m, n, p)=(3,3,1), the UE may perform interpolation between said CSI-RS channel estimates to generate a channel estimate for the antenna port corresponding to array position (m, n, p)=(3,3,1).

In some embodiments, the mapping between CSI-RS ports and antenna ports is constant across frequency. In other embodiments, said mapping may be different in different resource blocks. This may enable the UE to get wideband CSI of the full Nₚₒᵣₜₛ-port MIMO channel if it aggregates the partial channel estimates in the frequency domain.

Some independent or additional variants and embodiments comprise:

E1. A method for channel state information (CSI) reporting, e.g. in LTE, comprising that configuring a UE to measure upon a number N_{csi}_{_}ₚₒᵣₜₛ CSI-RS ports, while data transmission occurs over a larger number Nₚₒᵣₜₛ antenna ports. To the UE is conveyed information (e.g. configuration data pertaining to a joint CSI report) of how to relate said N_{csi}_{_}ₚₒᵣₜₛ CSI-RS ports to said antenna ports. The UE feeds back single PMI/CQI/RI report.

E2 Method of E1, wherein the information comprises defining a set of vertical CSI-RS ports and a set of horizontal CSI-RS ports.

E3. Method of E1 or E2, wherein the information comprises defining a mapping between CSI-RS port or port indices and antenna ports or port indices.

E4. Method of E1, E2 or E3, wherein the information further comprises information of the antenna configuration.

FIG. 1 shows a transmission structure of precoded spatial multiplexing mode in LTE.

FIG. 2 shows an illustration of a two-dimensional antenna array of cross-polarized antenna elements (Mₚ=2), with Mₕ=4 horizontal antenna elements and Mᵥ=8 vertical antenna elements, assuming one antenna element corresponds to one antenna port.

FIG. 3 shows antenna elements where a vertical CSI-RS process is transmitted.

FIG. 4 shows antenna elements where a horizontal CSI process is transmitted. The crossover element is indicated with a circle.

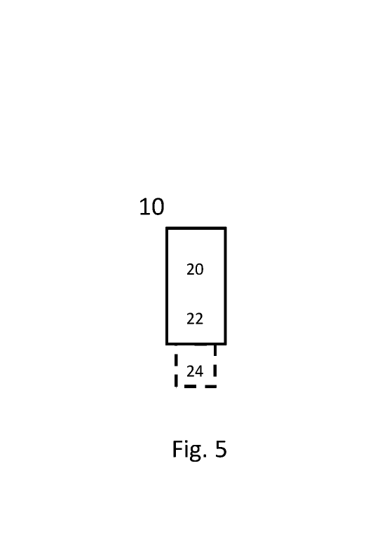

FIG. 5 schematically shows a terminal 10, which may be implemented in this example as a user equipment. Terminal 10 comprises control circuitry 20, which may comprise a controller connected to a memory. A receiving module and/or transmitting module and/or control or processing module and/or CIS receiving module and/or scheduling module, may be implemented in and/or executable by, the control circuitry 20, in particular as module in the controller. Terminal 10 also comprises radio circuitry 22 providing receiving and transmitting or transceiving functionality, the radio circuitry 22 connected or connectable to the control circuitry. An antenna circuitry 24 of the terminal 10 is connected or connectable to the radio circuitry 22 to collect or send and/or amplify signals. Radio circuitry 22 and the control circuitry 20 controlling it are configured for cellular communication with a network on a first cell/carrier and a second cell/carrier, in particular utilizing E-UTRAN/LTE resources as described herein. The terminal 10 may be adapted to carry out any of the methods for operating a terminal disclosed herein; in particular, it may comprise corresponding circuitry, e.g. control circuitry. Modules of a terminal as described herein may be implemented in software and/or hardware and/or firmware in corresponding circuitry.

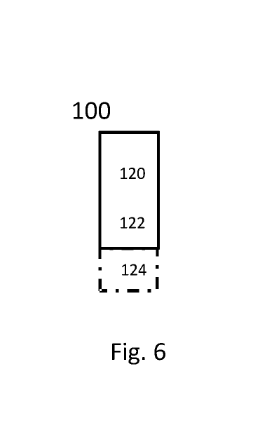

FIG. 6 schematically show a network node or base station 100, which in particular may be an eNodeB. Network node 100 comprises control circuitry 120, which may comprise a controller connected to a memory. A receiving module and/or transmitting module and/or control or processing module and/or scheduling module and/or CIS receiving module, may be implemented in and/or executable by the control circuitry 120. The control circuitry is connected to control radio circuitry 122 of the network node 100, which provides receiver and transmitter and/or transceiver functionality. An antenna circuitry 124 may be connected or connectable to radio circuitry 122 for signal reception or transmittance and/or amplification. The network node 100 may be adapted to carry out any of the methods for operating a network node disclosed herein; in particular, it may comprise corresponding circuitry, e.g. control circuitry.

Modules of a network node as described herein may be implemented in software and/or hardware and/or firmware in corresponding circuitry.

In the context of this description, wireless communication may be communication, in particular transmission and/or reception of data, via electromagnetic waves and/or an air interface, in particular radio waves, e.g. in a wireless communication network and/or utilizing a radio access technology (RAT). The communication may involve one or more than one terminal connected to a wireless communication network and/or more than one node of a wireless communication network and/or in a wireless communication network. It may be envisioned that a node in or for communication, and/or in, of or for a wireless communication network is adapted for communication utilizing one or more RATs, in particular LTE/E-UTRA.

A communication may generally involve transmitting and/or receiving messages, in particular in the form of packet data. A message or packet may comprise control and/or configuration data and/or payload data and/or represent and/or comprise a batch of physical layer transmissions. Control and/or configuration data may refer to data pertaining to the process of communication and/or nodes and/or terminals of the communication. It may, e.g., include address data referring to a node or terminal of the communication and/or data pertaining to the transmission mode and/or spectral configuration and/or frequency and/or coding and/or timing and/or bandwidth as data pertaining to the process of communication or transmission, e.g. in a header. Each node or terminal involved in communication may comprise radio circuitry and/or control circuitry and/or antenna circuitry, which may be arranged to utilize and/or implement one or more than one radio access technologies. Radio circuitry of a node or terminal may generally be adapted for the transmission and/or reception of radio waves, and in particular may comprise a corresponding transmitter and/or receiver and/or transceiver, which may be connected or connectable to antenna circuitry and/or control circuitry. Control circuitry of a node or terminal may comprise a controller and/or memory arranged to be accessible for the controller for read and/or write access. The controller may be arranged to control the communication and/or the radio circuitry and/or provide additional services. Circuitry of a node or terminal, in particular control circuitry, e.g. a controller, may be programmed to provide the functionality described herein. A corresponding program code may be stored in an associated memory and/or storage medium and/or be hardwired and/or provided as firmware and/or software and/or in hardware. A controller may generally comprise a processor and/or microprocessor and/or microcontroller and/or FPGA (Field-Programmable Gate Array) device and/or ASIC (Application Specific Integrated Circuit) device. More specifically, it may be considered that control circuitry comprises and/or may be connected or connectable to memory, which may be adapted to be accessible for reading and/or writing by the controller and/or control circuitry. Radio access technology may generally comprise, e.g., Bluetooth and/or Wifi and/or WIMAX and/or cdma2000 and/or GERAN and/or UTRAN and/or in particular E-Utran and/or LTE. A communication may in particular comprise a physical layer (PHY) transmission and/or reception, onto which logical channels and/or logical transmission and/or receptions may be imprinted or layered.

A node of a wireless communication network may be implemented as a terminal and/or user equipment and/or base station and/or relay node and/or any device generally adapted for communication in a wireless communication network, in particular cellular communication.

A cellular network may comprise a network node, in particular a radio network node, which may be connected or connectable to a core network, e.g. a core network with an evolved network core, e.g. according to LTE. A network node may e.g. be a base station. The connection between the network node and the core network/network core may be at least partly based on a cable/landline connection. Operation and/or communication and/or exchange of signals involving part of the core network, in particular layers above a base station or eNB, and/or via a predefined cell structure provided by a base station or eNB, may be considered to be of cellular nature or be called cellular operation.

A terminal may be implemented as a user equipment. A terminal or a user equipment (UE) may generally be a device configured for wireless device-to-device communication and/or a terminal for a wireless and/or cellular network, in particular a mobile terminal, for example a mobile phone, smart phone, tablet, PDA, etc. A user equipment or terminal may be a node of or for a wireless communication network as described herein, e.g. if it takes over some control and/or relay functionality for another terminal or node. It may be envisioned that terminal or a user equipment is adapted for one or more RATs, in particular LTE/E-UTRA. A terminal or user equipment may generally be proximity services (ProSe) enabled, which may mean it is D2D capable or enabled. It may be considered that a terminal or user equipment comprises radio circuitry and/control circuitry for wireless communication. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. It may be considered that a terminal or user equipment is configured to be a terminal or user equipment adapted for LTE/E-UTRAN.

A base station may be any kind of base station of a wireless and/or cellular network adapted to serve one or more terminals or user equipments. It may be considered that a base station is a node or network node of a wireless communication network. A network node or base station may be adapted to provide and/or define and/or to serve one or more cells of the network and/or to allocate frequency and/or time resources for communication to one or more nodes or terminals of a network. Generally, any node adapted to provide such functionality may be considered a base station. It may be considered that a base station or more generally a network node, in particular a radio network node, comprises radio circuitry and/or control circuitry for wireless communication. It may be envisioned that a base station or network node is adapted for one or more RATs, in particular LTE/E-UTRA. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry.

A base station may be arranged to be a node of a wireless communication network, in particular configured for and/or to enable and/or to facilitate and/or to participate in cellular communication, e.g. as a device directly involved or as an auxiliary and/or coordinating node. Generally, a base station may be arranged to communicate with a core network and/or to provide services and/or control to one or more user equipments and/or to relay and/or transport communications and/or data between one or more user equipments and a core network and/or another base station and/or be Proximity Service enabled. An eNodeB (eNB) may be envisioned as an example of a base station, e.g. according to an LTE standard. A base station may generally be proximity service enabled and/or to provide corresponding services. It may be considered that a base station is configured as or connected or connectable to an Evolved Packet Core (EPC) and/or to provide and/or connect to corresponding functionality. The functionality and/or multiple different functions of a base station may be distributed over one or more different devices and/or physical locations and/or nodes. A base station may be considered to be a node of a wireless communication network. Generally, a base station may be considered to be configured to be a coordinating node and/or to allocate resources in particular for cellular communication between two nodes or terminals of a wireless communication network, in particular two user equipments.

It may be considered for cellular communication there is provided at least one uplink (UL) connection and/or channel and/or carrier and at least one downlink (DL) connection and/or channel and/or carrier, e.g. via and/or defining a cell, which may be provided by a network node, in particular a base station or eNodeB. An uplink direction may refer to a data transfer direction from a terminal to a network node, e.g. base station and/or relay station. A downlink direction may refer to a data transfer direction from a network node, e.g. base station and/or relay node, to a terminal. UL and DL may be associated to different frequency resources, e.g. carriers and/or spectral bands. A cell may comprise at least one uplink carrier and at least one downlink carrier, which may have different frequency bands. A network node, e.g. a base station or eNodeB, may be adapted to provide and/or define and/or control one or more cells, e.g. a PCell and/or a LA cell.

A network node, in particular a base station, and/or a terminal, in particular a UE, may be adapted for communication in spectral bands (frequency bands) licensed and/or defined for LTE. In addition, a network node, in particular a base station/eNB, and/or a terminal, in particular a UE, may be adapted for communication in freely available and/or unlicensed/LTE-unlicensed spectral bands (frequency bands), e.g. around 5 GHz.

Configuring a terminal or wireless device or node may involve instructing and/or causing the wireless device or node to change its configuration, e.g. at least one setting and/or register entry and/or operational mode. A terminal or wireless device or node may be adapted to configure itself, e.g. according to information or data in a memory of the terminal or wireless device. Configuring a node or terminal or wireless device by another device or node or a network may refer to and/or comprise transmitting information and/or data and/or instructions to the wireless device or node by the other device or node or the network, e.g. allocation data and/or scheduling data and/or scheduling grants.

A wireless communication network may comprise a radio access network (RAN), which may be adapted to perform according to one or more standards, in particular LTE, and/or radio access technologies (RAT).

A network device or node and/or a wireless device may be or comprise a software/program arrangement arranged to be executable by a hardware device, e.g. control circuitry, and/or storable in a memory, which may provide the described functionality and/or corresponding control functionality.

A cellular network or mobile or wireless communication network may comprise e.g. an LTE network (FDD or TDD), UTRA network, CDMA network, WiMAX, GSM network, any network employing any one or more radio access technologies (RATs) for cellular operation. The description herein is given for LTE, but it is not limited to the LTE RAT.

RAT (radio access technology) may generally include: e.g. LTE FDD, LTE TDD, GSM, CDMA, WCDMA, WiFi, WLAN, WiMAX, etc.

A storage medium may be adapted to store data and/or store instructions executable by control circuitry and/or a computing device, the instruction causing the control circuitry and/or computing device to carry out and/or control any one of the methods described herein when executed by the control circuitry and/or computing device. A storage medium may generally be computer-readable, e.g. an optical disc and/or magnetic memory and/or a volatile or non-volatile memory and/or flash memory and/or RAM and/or ROM and/or EPROM and/or EEPROM and/or buffer memory and/or cache memory and/or a database.

Resources or communication resources or radio resources may generally be frequency and/or time resources (which may be called time/frequency resources). Allocated or scheduled resources may comprise and/or refer to frequency-related information, in particular regarding one or more carriers and/or bandwidth and/or subcarriers and/or time-related information, in particular regarding frames and/or slots and/or subframes, and/or regarding resource blocks and/or time/frequency hopping information. Allocated resources may in particular refer to UL resources, e.g. UL resources for a first wireless device to transmit to and/or for a second wireless device. Transmitting on allocated resources and/or utilizing allocated resources may comprise transmitting data on the resources allocated, e.g. on the frequency and/or subcarrier and/or carrier and/or timeslots or subframes indicated. It may generally be considered that allocated resources may be released and/or de-allocated. A network or a node of a network, e.g. an allocation or network node, may be adapted to determine and/or transmit corresponding allocation data indicating release or de-allocation of resources to one or more wireless devices, in particular to a first wireless device. Resources may comprise for example one or more resource elements and/or resource blocks.

Allocation data may be considered to be data indicating and/or granting resources allocated by the controlling or allocation node, in particular data identifying or indicating which resources are reserved or allocated for communication for a wireless device and/or which resources a wireless device may use for communication and/or data indicating a resource grant or release. A grant or resource or scheduling grant may be considered to be one example of allocation data. Allocation data may in particular comprise information and/or instruction regarding a configuration and/or for configuring a terminal, e.g. for HARQ bundling and/or which HARQ bundling method to perform and/or how to perform HARQ bundling. Such information may comprise e.g. information about which carriers (and/or respective HARQ feedback) to bundle, bundle size, method to bundle (e.g. which operations to perform, e.g. logical operations), etc., in particular information pertaining to and/or indicating the embodiments and methods described herein. It may be considered that an allocation node or network node is adapted to transmit allocation data directly to a node or wireless device and/or indirectly, e.g. via a relay node and/or another node or base station. Allocation data may comprise control data and/or be part of or form a message, in particular according to a pre-defined format, for example a DCI format, which may be defined in a standard, e.g. LTE. Allocation data may comprise configuration data, which may comprise instruction to configure and/or set a user equipment for a specific operation mode, e.g. in regards to the use of receiver and/or transmitter and/or transceiver and/or use of transmission (e.g. TM) and/or reception mode, and/or may comprise scheduling data, e.g. granting resources and/or indicating resources to be used for transmission and/or reception. A scheduling assignment may be considered to represent scheduling data and/or be seen as an example of allocation data. A scheduling assignment may in particular refer to and/or indicate resources to be used for communication or operation.

A terminal or user equipment may generally be operable with and/or connected or connectable to and/or comprise an antenna arrangement or antenna array, in particular a 2-d array, adapted for MIMO operation and/or comprising a plurality of individually controllable antenna elements. Generally, a terminal or UE may be a terminal or UE for or in a wireless communication network.

A network node may generally be operable with and/or connected or connectable to and/or comprise an antenna arrangement or antenna array, in particular a 2-d array, adapted for MIMO operation and/or comprising a plurality of individually controllable antenna elements. Generally, a network node, in particular an eNodeB, may be a network node for or in a wireless communication network.

A terminal or user equipment (UE) may generally be adapted to receive, and/or receive and/or comprise a receiving module for receiving, CSI-RS signaling, e.g. from a network node or network. The terminal or user equipment may be adapted to provide (e.g., by transmitting), and/or provide and/or comprise a feedback module for providing, CSI feedback, in particular CSI feedback comprising RI and/or PMI and/or CQI. A network node, e.g. an eNodeB, may be adapted to provide (e.g. by transmitting), and/or provide and/or comprise a CSI providing module, CSI-RS signaling, e.g. to one or more than one terminals or UEs. It may be considered that a network node is adapted to receive, and/or receives and/or comprises a feedback receiving module, for receiving CSI feedback, e.g. from one or more terminals or UEs.

An antenna arrangement or array may comprise a number of antenna ports, wherein each port may be controlled independently; to each port there may be mapped and/or associated one or more antenna elements.

The CSI-RS may be separated in partial channels and/or CSI-RS for partial channels and/or separate and/or orthogonal dimensions, e.g. CSI-RSH and CSI-RSV (or, in other words, a vertical and a horizontal component, which may be defined in regards to the arrangement of the antenna array used). The CSI-RS for the partial channels may be arranged to not reflect the full channel conditions, e.g. because the number of CSI-RS components / partial channels is lower than the number of antenna elements used for transmission.

Providing CSI-RS signaling may comprise utilizing a multi-antenna array, in particular a 2D antenna array. Providing the signaling may be based on a mapping of antenna elements to ports and/or comprise antenna virtualization, wherein a number of (physical) antenna elements are mapped to a number of virtual antenna elements, wherein the number of (physical) antenna elements may be larger than the number of virtual antenna elements. A port may generally comprise a mapping for signals (in particular, CSI-RS signaling or data, e.g. user data) to antenna elements, which may be physical or virtual elements. The CSI-RS signaling respectively a corresponding CSI process or feedback may pertain to two separate and/or independent dimensions, e.g. horizontal and vertical. An antenna port generally may be a generic term for signal transmission under identical channel conditions. An antenna element may be associated to one or more than one (logical) ports. The terms “port” and “antenna port” may be used interchangeably. Symbols or Signals transmitted via identical antenna ports may generally be assumed to be subject to the same channel conditions. Antenna ports and/or corresponding mappings may be defined by a standard, in particular LTE. Separate ports may be different regarding channel conditions and/or antenna mapping. A CSI (or CIS-RS) port may be a port defined for CSI/CSI-RS signaling, whereas a data transmission port (or data port) may a port defined for data transmission. Data transmission in this context in particular may refer to data not related to CSI-Rs signaling, e.g. user data transmission, and/or data transmission using ports based on CSI-feedback. The data ports may be different from the CSI ports, in particular regarding their antenna mapping. However, some of the data ports may map antenna elements identically to some of the CSI ports. The CSI ports may generally be considered to be separate from each other. The data ports may generally be considered to be separate from each other as well. A CSI/CSI-RS port may comprise associated CSI-RS signaling, on which for example measurements may be performed by the receiving node, and/or such signaling may be provided for a CSI-RS port.

Some useful abbreviations include:

| Abbreviation | Explanation |
|---|---|
| CCA | Clear Channel Assessment |
| DCI | Downlink Control Information |
| DMRS | Demodulation Reference Signals |
| eNB | evolved NodeB, base station |
| TTI | Transmission-Time Interval |
| UE | User Equipment |
| LA | Licensed Assisted |
| LAA | Licensed Assisted Access |
| DRS | Discovery Reference Signal |
| SCell | Secondary Cell |
| SRS | Sounding Reference Signal |
| LBT | Listen-before-talk |
| PCFICH | Physical Control Format Indicator Channel |
| PDCCH | Physical Downlink Control Channel |
| PUSCH | Physical Uplink Shared Channel |
| PUCCH | Physical Uplink Control Channel |
| RRM | Radio Resource Management |
| CIS | Transmission Confirmation Signal |
| 3GPP | 3^{rd} Generation Partnership Project |
| Ack/Nack | Acknowledgment/Non-Acknowledgement, also A/N |
| AP | Access point |
| B1, B2, . . . Bn | Bandwidth of signals, in particular carrier bandwidth Bn assigned to |
| | corresponding carrier or frequency f1, f2, . . . , fn |
| BER/BLER | Bit Error Rate, BLock Error Rate; |
| BS | Base Station |
| CA | Carrier Aggregation |
| CoMP | Coordinated Multiple Point Transmission and Reception |
| CQI | Channel Quality Information |
| CRS | Cell-specific Reference Signal |
| CSI | Channel State Information |
| CSI-RS | CSI reference signal |
| D2D | Device-to-device |
| DL | Downlink; generally referring to transmission of data to a node/into a |
| | direction further away from network core (physically and/or logically); in |
| | particular from a base station or eNodeB terminal; more generally, may refer to |
| | transmissions received by a terminal or node (e.g. in a D2D environment); often |
| | uses specified spectrum/bandwidth different from UL (e.g. LTE) |
| eNB | evolved NodeB; a form of base station, also called eNodeB |
| EPDCCH | Enhanced Physical DL Control CHannel |
| E-UTRA/N | Evolved UMTS Terrestrial Radio Access/Network, an example of a |
| | RAT |
| f1, f2, f3, . . . , fn | carriers/carrier frequencies; different numbers may indicate that the |
| | referenced carriers/frequencies are different |
| f1_UL, . . . , fn_UL | Carrier for Uplink/in Uplink frequency or band |
| f1_DL, . . . , fn_DL | Carrier for Downlink/in Downlink frequency or band |
| FDD | Frequency Division Duplexing |
| ID | Identity |
| L1 | Layer 1 |
| L2 | Layer 2 |
| HARQ | Hybrid Automatic Repeat reQuest |
| LTE | Long Term Evolution, a telecommunications standard |
| MAC | Medium Access Control |
| MBSFN | Multiple Broadcast Single Frequency Network |
| MCS | Modulation and Coding Scheme |
| MDT | Minimisation of Drive Test |
| MIMO | Multiple Input, Multiple Output (techniques for multi-antenna arrays) |
| NW | Network |
| OFDM | Orthogonal Frequency Division Multiplexing |
| O&M | Operational and Maintenance |
| OSS | Operational Support Systems |
| PC | Power Control |
| PDCCH | Physical DL Control CHannel |
| PH | Power Headroom |
| PHR | Power Headroom Report |
| PMI | Precoding Matrix Indicator |
| PRB | Physical Resource Block |
| PSS | Primary Synchronization Signal |
| PUSCH | Physical Uplink Shared CHannel |
| R1, R2, . . . , Rn | Resources, in particular time-frequency resources, in particular |
| | assigned to corresponding carrier f1, f2, . . . , fn |
| RA | Random Access |
| RACH | Random Access CHannel |
| RAT | Radio Access Technology |
| RE | Resource Element |
| RB | Resource Block |
| RI | Rank Indicator |
| RRC | Radio Resource Control |
| RRH | Remote radio head |
| RRM | Radio Resource Management |
| RRU | Remote radio unit |
| RSRQ | Reference signal received quality |
| RSRP | Reference signal received power |
| RSSI | Received signal strength indicator |
| RX | reception/receiver, reception-related |
| SA | Scheduling Assignment |
| SINR/SNR | Signal-to-Noise-and-Interference Ratio; Signal-to-Noise Ratio |
| SFN | Single Frequency Network |
| SON | Self Organizing Network |
| SR | Scheduling Request |
| SSS | Secondary Synchronization Signal |
| TPC | Transmit Power Control |
| TX | transmission/transmitter, transmission-related |
| TDD | Time Division Duplexing |
| UE | User Equipment |
| UL | Uplink; generally referring to transmission of data to a node/into a |
| | direction closer to a network core (physically and/or logically); in particular from a |
| | D2D enabled node or UE to a base station or eNodeB; in the context of D2D, it may |
| | refer to the spectrum/bandwidth utilized for transmitting in D2D, which may be the |
| | same used for UL communication to a eNB in cellular communication; in some D2D |
| | variants, transmission by all devices involved in D2D communication may in some |
| | variants generally be in UL spectrum/bandwidth/carrier/frequency; generally, UL |
| | may refer to transmission by a terminal (e.g. to a network or network node or |
| | another terminal, for example in a D2D context). |

These and other abbreviations may be used according to LTE standard definitions.

1-9. (canceled)

10. A method for operating a multiple-input multiple-output (MIMO) transmitting node for a wireless communication network, the method comprising configuring a receiving node for determining channel state information (CSI) feedback for a first number Ncsi_ports of separate CSI reference symbol (CSI-RS) ports, the first number Ncsi_ports being smaller than a second number Nports of ports used for data transmission to the receiving node, wherein configuring comprises signaling the first number Ncsi_ports and the second number Nports to the receiving node.

11. The method of claim 10, wherein the MIMO transmitting node is a network node or an eNodeB.

12. A multiple-input multiple-output (MIMO) transmitting node for a wireless communication network, the MIMO transmitting node being adapted to configure a receiving node for determining channel state information (CSI) feedback for a first number Ncsi_ports of separate CSI reference symbol (CSI-RS) ports, the first number Ncsi_ports being smaller than a second number Nports of ports used for data transmission to the receiving node, wherein configuring comprises signaling the first number Ncsi_ports and the second number Nports to the receiving node.

13. The MIMO transmitting node of claim 12, wherein the MIMO transmitting node is a network node or eNodeB.

14. A method for operating a receiving node for a wireless communication network, the method comprising measuring channel state information (CSI) information of a transmission from a transmitting node on a first number Ncsi_ports of CSI reference symbol (CSI-RS) ports, and determining a joint CSI report based on the measured CSI information out of the first number Ncsi_ports of CSI ports and/or processes.

15. The method of claim 14, wherein the receiving node is a terminal.

16. A receiving node for a wireless communication network, the receiving node being adapted to measure channel state information (CSI) information of a transmission from a transmitting node on a first number Ncsi_ports of CSI reference symbol (CSI-RS) ports, and determining a joint CSI report based on the measured CSI information out of the first number Ncsi_ports of CSI ports and/or processes.

17. The receiving node of claim 16, wherein the receiving node is a terminal.

18. A non-transitory computer-readable storage medium adapted to store instructions executable by control circuitry, the instructions being configured to cause the control circuitry to carry out the method of claim 10 when executed by the control circuitry.
